(19) United States
(12) Patent Application Publication
(10) Pub. No.: US 2022/0150046 A1
(43) Pub. Date: May 12, 2022

(54) DETERRING SIDE CHANNEL ANALYSIS ATTACKS FOR DATA PROCESSORS HAVING PARALLEL CRYPTOGRAPHIC CIRCUITS

(71) Applicant: Intel Corporation, Santa Clara, CA (US)

(72) Inventors: Dumitru-Daniel Dinu, Chandler, AZ (US); Emre Karabulut, Raleigh, NC (US); Aditya Katragada, Austin, TX (US); Geoffrey Strongin, Tigard, OR (US); Avinash L. Varna, Chandler, AZ (US)

(73) Assignee: Intel Corporation, Santa Clara, CA (US)

(21) Appl. No.: 17/477,028

(22) Filed: Sep. 16, 2021

(51) Int. Cl. H04L 9/00; G06F 21/72

(52) U.S. Cl. CPC H04L 9/003; G06F 21/72

(57) ABSTRACT

A security processor includes a scheduler to read input data blocks from an input buffer, send the input data blocks to one or more cryptographic circuits in a first random order; and send data blocks having random values in a second random order to one or more of the cryptographic circuits that did not receive the input data blocks.

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

Data processors having cryptographic circuits are susceptible to side channel analysis (SCA) attacks that exploit their power consumption or electromagnetic (EM) radiation to extract secret information manipulated during the execution of cryptographic operations. Protecting data processors having cryptographic circuits against these types of attacks is challenging.

Existing approaches for countermeasures can be split into two categories: hiding and masking. Hiding aims to reduce the data dependency of the observable leakage (e.g., power, EM emissions), whereas masking randomizes the intermediate values processed within a cryptographic circuit. Countermeasures against power and EM attacks, such as hiding and masking, add a considerable overhead to the unprotected implementation of cryptographic operations, affecting circuitry area, latency, throughput, maximum frequency, and/or power consumption by a factor of approximately two or three or more. In addition, existing countermeasures continuously require fresh random values that are expensive to generate in terms of throughput. Hence, these countermeasures are not applicable to high-throughput data processing scenarios, which are characterized by a large area and power consumption, because the overhead of these countermeasures is unacceptable.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a block diagram of a computing system according to one or more embodiments.

FIG. 2 is a block diagram of a security processor according to one or more embodiments.

FIG. 3 is a block diagram of a scheduler according to one or more embodiments.

FIG. 4 is a flow diagram of scheduler processing according to one or more embodiments.

FIG. 5 is a schematic diagram of an illustrative electronic computing device to perform cryptographic processing according to some embodiments.

### DETAILED DESCRIPTION

The technology described herein deters SCA attacks against data processors having parallel instantiations of unrolled and pipelined cryptographic circuits. Embodiments provide an improved low-overhead approach that is suitable for data processors having high-throughput cryptographic circuits. Embodiments include a scheduler situated between parallel instantiations of unrolled and pipelined cryptographic circuits and the one or more input buffers from which the cryptographic circuits consume data. The scheduler comprises between one and four SCA deterrence techniques: 1) randomizing the order in which the input data from the input buffer is allocated across the cryptographic circuits (denoted S1 herein); 2) providing random input data to the cryptographic circuits that would otherwise be idle (denoted S2 herein); 3) randomly clocking some of the cryptographic circuits on the positive clock edge and the remaining cryptographic circuits on the negative clock edge (denoted T1 herein); and 4) inserting random delays between transfers of the input data blocks processed by each cryptographic circuit (denoted T2 herein).

The scheduler protects the cryptographic circuits against SCA attacks by exploiting the parallelism of the unrolled and pipelined cryptographic circuits to randomize the data dependency of the observable leakage in space (S1, S2) and time (T1, T2). Each of the four techniques (S1, S2, T1, T2) can be applied independently or in conjunction with one or more of the others, in any combination. In an embodiment, all four techniques are applied. The application of these techniques in data processors does not change the implementation of the cryptographic circuits nor their performance characteristics. This is desirable for high-throughput applications, including encryption/decryption of communications links and memory.

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

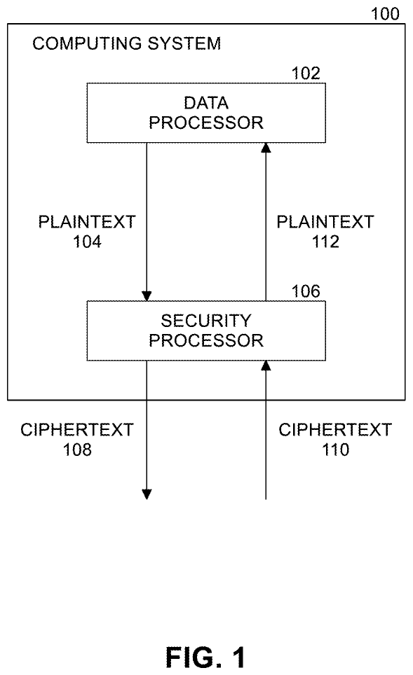

Referring now to FIG. 1, an illustrative computing system 100 for secure data processing includes a data processor 102 communicating with security processor 106. Data processor 102 sends plaintext data 104 to security processor 106. Security processor 106 performs cryptographic operations. For example, security processor 106 encrypts plaintext data 104 into ciphertext data 108. Security processor 106 may receive ciphertext data 110. For example, security processor decrypts ciphertext data 110 into plaintext data 112 and sends plaintext data 112 to data processor 102. This processing protects plaintext data 104 outside of computing system 100 and allows ciphertext data 110 to be processed in a decrypted form within computing system 100.

Computing system 100 can be embodied as any type of electronic device capable of performing data processing functions and making use of security processing performed by security processor 106. For example, computing system 100 can be implemented as, without limitation, a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a disaggregated server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

It is to be appreciated that lesser or more equipped computing systems 100 than the examples described above may be preferred for certain implementations. Therefore, the configuration of computing system 100 can vary from implementation to implementation depending upon numerous factors, such as price constraints, performance requirements, technological improvements, or other circumstances.

The technology described herein for data processor 102 and security processor 106 can be implemented as any or a combination of one or more microchips or integrated circuits interconnected using a parent board, hardwired logic, software stored by a memory device and executed by a microprocessor, firmware, an application specific integrated circuit (ASIC), and/or a field programmable gate array (FPGA). The term “logic” includes, by way of example, software or hardware and/or combinations of software and hardware. In an embodiment, data processor 102 comprises one or more processors or processor cores, memory controller circuitry, or accelerator circuitry. In an embodiment, security processor may be integral with data processor 102. In an embodiment, data processor 102 and security processor 106 may be resident on a single integrated circuit die (e.g., a system on a chip (SOC)).

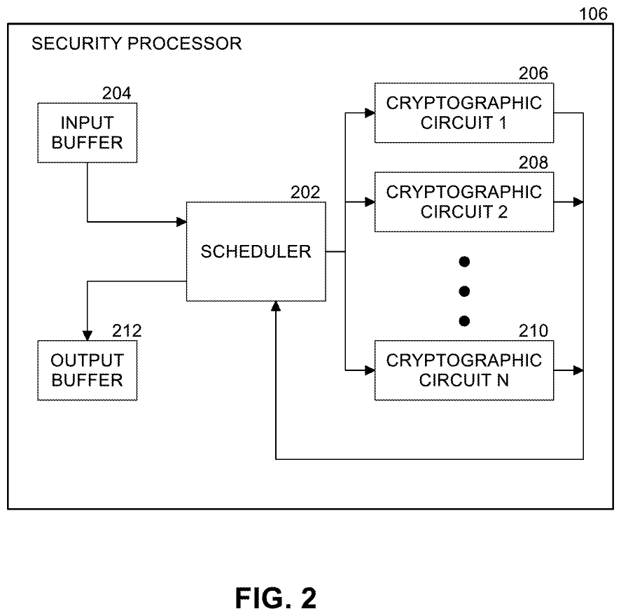

FIG. 2 is a block diagram of security processor 106 according to one or more embodiments. In one or more embodiments, scheduler 202 is inserted between data buffers, such as input buffer 204 and output buffer 212, and a plurality of cryptographic circuits. Although only one input buffer 204 and one output buffer 212 are depicted in FIG. 2, security processor 106 may include any number of input buffers and output buffers. Scheduler 202 reads input data from input buffer 204, sends the input data in a manner described below to the plurality of cryptographic circuits shown in FIG. 2 as cryptographic circuit 1 206, cryptographic circuit 2 208, . . . cryptographic circuit N 210, where N is a natural number, receives output data from the plurality of cryptographic circuits, and writes the output data to output buffer 212. In an embodiment, the plurality of cryptographic circuits 206, 208, . . . 210 comprise unrolled and pipelined cryptographic circuits to perform cryptographic operations (e.g., encryption, decryption, etc.) according to any suitable cryptographic process. In an embodiment, the plurality of cryptographic circuits 206, 208, . . . 210 performs cryptographic operations on the input data to produce the output data. In an embodiment, the cryptographic circuits operate on blocks of data. In an example, the input data may be plaintext data 104 and the plurality of the cryptographic circuits 206, 208, . . . 210 encrypts the plaintext data 104 into ciphertext data 108. In another example, the input data may be ciphertext data 110 and the plurality of the cryptographic circuits 206, 208, . . . 210 decrypts the ciphertext data 110 into plaintext data 112. Other cryptographic operations may also be performed by the plurality of cryptographic circuits 206, 208, . . . 210.

In one embodiment, scheduler 202 implements technique 51 and randomly assigns input data from the input buffer 204 across one or more of the plurality of cryptographic circuits 206, 208, . . . 210; in other words, the scheduler disrupts the relationship between the order of the data blocks of the input data and the cryptographic circuits that processes the data blocks. This can be done adaptively, based on the load of the cryptographic circuit. When there is not enough input data available in input buffer 204, in an embodiment scheduler 202 implements technique S2 and randomly generates input data values for those one or more of the plurality of cryptographic circuits 206, 208, . . . 210 that otherwise would be idle.

Thus, when there is enough input data, the input data blocks are processed in random order. When there is not enough data, random “dummy” data blocks are generated to keep the cryptographic circuits busy. When there is a decreasing amount of data in the input buffer (below a certain threshold), random “dummy” data blocks may be sent to the cryptographic circuits. In other words, the scheduler predicts that the current data flow will run out of data blocks and starts to compensate with random “dummy” data blocks.

In an embodiment, scheduler 202 implements technique T1 and provides options to randomly clock one or more of the plurality of cryptographic circuits 206, 208, . . . 210 on the positive clock edge and the remaining one or more of the plurality of cryptographic circuit on the negative clock edge. In an embodiment, scheduler 202 implements technique T2 and inserts random delays between sending of data blocks of input buffer 204 to be processed by the plurality of cryptographic circuits 206, 208, . . . 210.

Each cryptographic circuit may use a different secret key than other cryptographic circuits to process the input data assigned by scheduler 202. The secret key used by a cryptographic circuit may change from one execution of the cryptographic circuit to another execution.

The technology described herein exploits two levels of parallelism: (1) the parallelism of the cryptographic circuits that execute operations at the same time; and (2) the parallelism generated by unrolling and pipelining each of the cryptographic circuits. Consequently, the signal-to-noise ratio (SNR) of the present approach is reduced compared to the SNR of a single iterative cryptographic circuit.

Unlike other countermeasures which use time or data randomization, the technology described herein uses space randomization to reduce the data dependency of the observable leakage. More precisely, an attacker cannot identify which two inputs or outputs were consecutively processed by the same cryptographic circuit using the same key(s). Hence, the attacker is forced to use a weaker hypothesis for the intermediate value being attacked. Compared to an existing countermeasure, this space randomization achieves the same deterrent effect without halving the throughput of the cryptographic circuits. Moreover, space randomization requires substantially fewer fresh random data values (which are expensive to generate), and consequently has a lower randomness overhead compared to existing countermeasures.

Scheduler 202 provides random input data values to the cryptographic circuits that would otherwise be idle for at least two reasons: (1) to keep the SNR low; and (2) to deter static power analysis attacks. It has been observed that this idleness condition rarely occurs in practice because parallel instantiations of unrolled and pipelined cryptographic circuits are typically used in high-throughput scenarios, such as network accelerators, in which an attacker may not have full control of the traffic. However, in the technology described herein the cryptographic circuits are protected whenever this infrequent situation materializes.

Randomly changing initiating operations of the cryptographic circuits between the positive and negative clock edges, as well as inserting random delays between communication of the input data blocks to each cryptographic circuit further reduces the SNR through time randomization. Therefore, an attacker is forced to apply additional preprocessing steps to the power or EM traces being collected to be able to mount an attack on the cryptographic circuits. Hence, these two techniques further increase the resistance to side-channel attacks. Each technique (S1, S2, T1, and T2) can be applied independently or in conjunction with one or more of the others. Application of all four techniques provides an improved deterrence over any individual technique or lesser combination of techniques.

The technology described herein provide at least two advantages. First, embodiments do not employ any modifications of the cryptographic circuits. Second, embodiments add a lower overhead as compared to other existing countermeasures. The area of scheduler 202 in computing system 100 circuitry is negligible compared to the area of existing SCA attack countermeasures. Moreover, the latency, throughput, and maximum frequency of the cryptographic circuits are not affected by scheduler 202. Finally, the randomness requirement is greatly reduced.

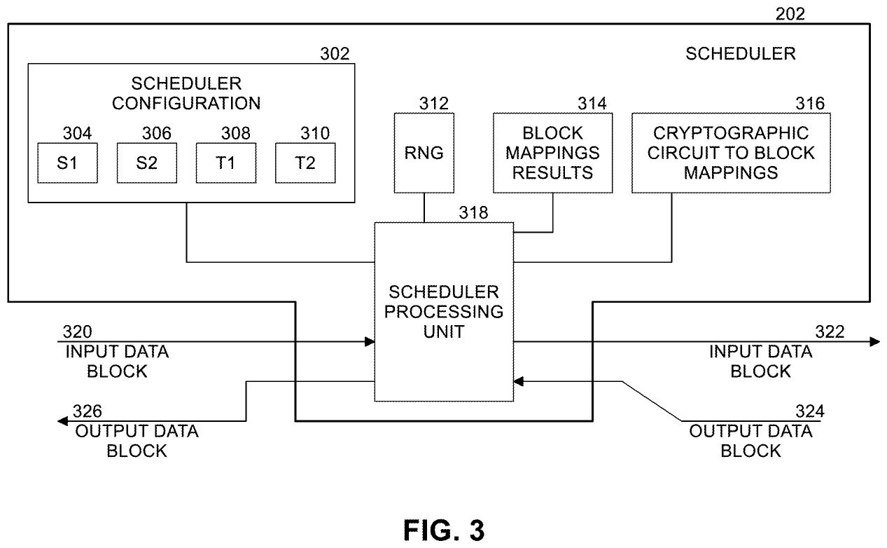

FIG. 3 is a block diagram of scheduler 202 according to one or more embodiments. In an embodiment, scheduler 202 includes one or more scheduler configurations 302. Scheduler configurations 302 comprise settings for one or more parameters for S1 304, S2 306, T1 308, and T2 310. In an embodiment, S1 304, S2 306, T1 308, and T2 310 comprise binary flags that, when set, indicate scheduler 202 is to apply the selected technique(s), and when cleared, indicated scheduler 202 to not apply the selected technique(s). Thus, the selection of the scheduler configurations for the S1, S2, T1, and T2 parameters are independently configurable. Scheduler 202 includes at least one random number generator (RNG) 312 to generate random numbers. Scheduler 202 includes block mappings results 314 to store results received from processing of input data blocks by cryptographic circuits 206, 208, . . . 210. Scheduler 202 includes cryptographic circuit to block mappings 316 to associate cryptographic circuits with index values representing data blocks.

In an embodiment, the index values are used to identify the order of the input data blocks in the input buffer 204. The index values are used for reconstruction of the same order of data blocks in the output buffer 212. Index values can be assigned using a counter or a unique identifier (e.g., a stream of bits). The RNG 312 is used to randomly select the input data blocks to be processed based on their index value. Each index value should uniquely identify the location of a data block in the input buffer/output buffer.

Scheduler 202 includes scheduler processing unit 318 to control scheduler processing. Scheduler processing unit 318 controls reading an input data block 320 from input buffer 204, determining which cryptographic circuit to send the input data block to, determining when to send the input data block 322 to the determined cryptographic circuit (e.g., inserting random delays between data transfers), determining whether the determined cryptographic circuit is clocked on the positive edge or the negative edge, and determining whether to send an input data block 322 having random values to the determined cryptographic circuit. Input data block 322 may comprise input data block 320 or random values. Scheduler processing unit 318 stores information regarding which cryptographic circuit was sent which input data block 322 in cryptographic circuit to block mappings 316. Scheduler processing unit 318 sends input block 322 to the determined cryptographic circuit. Scheduler processing unit 318 receives an output data block 324 from a cryptographic circuit, temporarily stores output data block 324 in block mappings results 314 and transfers output data block 326 to output buffer 212. In an embodiment, output data block 324 is the same as output data block 326. In an embodiment, scheduler processing unit 318 uses RNG 312 to randomize which cryptographic circuit receives an input data block and to generate random “dummy” values for input data block 322 for a cryptographic circuit that may otherwise be currently idle.

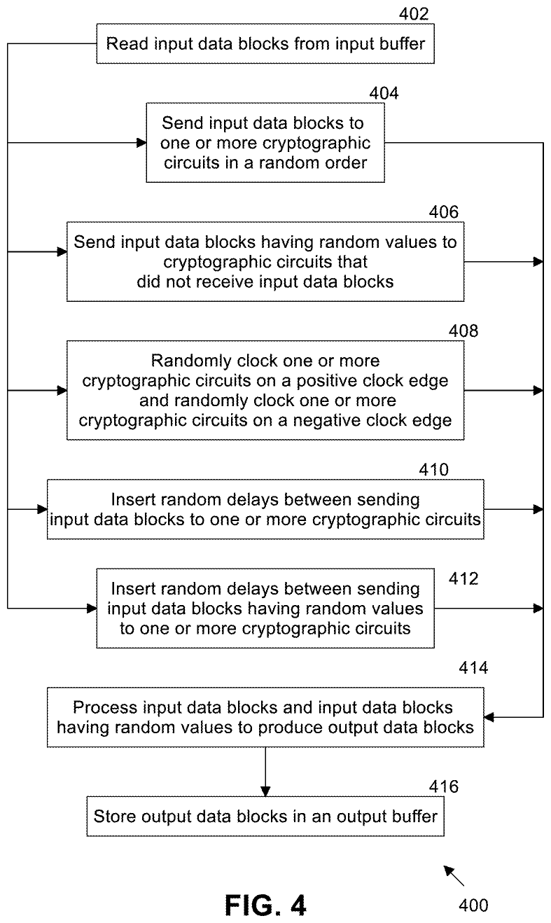

FIG. 4 is a flow diagram 400 of scheduler 202 processing according to one or more embodiments. At block 402, scheduler 202 reads input data blocks 320 from input buffer 204. At block 404, scheduler 202 sends input data blocks 322 to one or more of cryptographic circuits 206, 208, . . . 210 in a first random order. At block 406, scheduler 202 sends input data blocks 322 having values in a second random order to one or more cryptographic circuits 206, 208, . . . 210 that did not receive input data blocks 320. In an embodiment, the first random order and the second random order are generated by RNG 312 and are different. At block 408, scheduler 202 randomly clocks one or more cryptographic circuits on a positive clock edge and randomly clocks one or more cryptographic circuits on a negative clock edge. At block 410, scheduler 202 inserts random delays between sending input data blocks 322 to the one or more cryptographic circuits. At block 412, scheduler 202 inserts random delays between sending input data blocks having random values to the one or more cryptographic circuits. In an embodiment, scheduler 202 implements any one or more of blocks 404, 406, 408, 410, and 412. At block 414, the input data blocks and the input data blocks having random values are processed by the plurality of cryptographic circuits to produce output data blocks 324. In an embodiment, scheduler 202 directs the cryptographic circuits to process the input data blocks. At block 416, scheduler 202 stores output data blocks 324 in output buffer 212.

In an embodiment, storing the one or more output data blocks comprises omitting storing the output data blocks produced by the one or more cryptographic circuits that received the data blocks having random values. Since these random values are dummy values, they do not need to be returned.

In an embodiment, the plurality of cryptographic circuits comprises a plurality of unrolled and pipelined cryptographic circuits operating in parallel, the input data blocks comprise plaintext data, the output data blocks comprise ciphertext data, and the plurality of cryptographic circuits perform encryption processing. In another embodiment, the input data blocks comprise ciphertext data, the output data blocks comprise plaintext data, and the plurality of cryptographic circuits perform decryption processing.

In an embodiment implementing a first technique of randomly clocking one or more cryptographic circuits on a positive clock edge and randomly clocking one or more cryptographic circuits on a negative clock edge, a second technique of inserting random delays between sending the input data blocks to the one or more of cryptographic circuits and between sending the data blocks having random values to the one or more cryptographic circuits, a third technique of the sending the input data blocks to one or more of cryptographic circuits in the random order, and a fourth technique of the sending data blocks having random values to one or more cryptographic circuits that did not receive the input data blocks, the techniques are performed according to settings of independently configurable parameters for the techniques in any combination.

Table 1 shows an example implementation of scheduler processing in pseudo-code form.

```
TABLE 1
© 2021 Intel Corporation
def SchedulerProcessingUnit(input_buffer, output_buffer):
  S1, S2, T1, T2 = read_configuration( )
  random_number_generator = init_random_number_generator( )
  # One entry for each cryptographic circuit (CC): each entry is a pair
(′CCID′,′random_index′), where ′CCID′ is the CC that processes the data block from
′random_index′ in ′input_buffer′.
  CC_to_block_mappings = { }
  # One entry for each CC: each entry contains the resulting data block from the corresponding
CC.
  results = { }
  InputProcessingThread: while True:
    while data in input_buffer:
      if T1:
        for CCID in CCs:
          random_edge = random_number_generator.get_random_clock_edge( )
          CCID.set_edge(random_edge)
      if T2:
        for CCID in CCs:
          random_sleep = random_number_generator.get_random_sleep( )
          CCID.sleep(random_sleep)
      if S1:
        for CCID in CCs:
          if CCID.is_idle( ):
            random_index = random_number_generator.get_random_index( )
            CC_to_block_mappings.add((CCID, random_index))
            results[CCID] = CCID.process(input_buffer[random_index])
        if S2:
          for CCID in CCs:
            if CCID.is_idle( ):
              random_block = random_number_generator.get_random_block( )
              results[CCID] = CCID.process(random_block)
              CC_to_block_mappings.add((CCID, −1))
  OutputProcessingThread: while True:
    while data in results:
      for CCID_to_block_mapping in CC_to_block_mappings:
        (CCID, random_index) = CCID_to_block_mapping
        if random_index != −1:
          output_buffer[random_index] = results[CCID]
        else:
          discard(results[CCID])
        CC_to_block_mappings.remove(CCID_to_block_mapping)
```

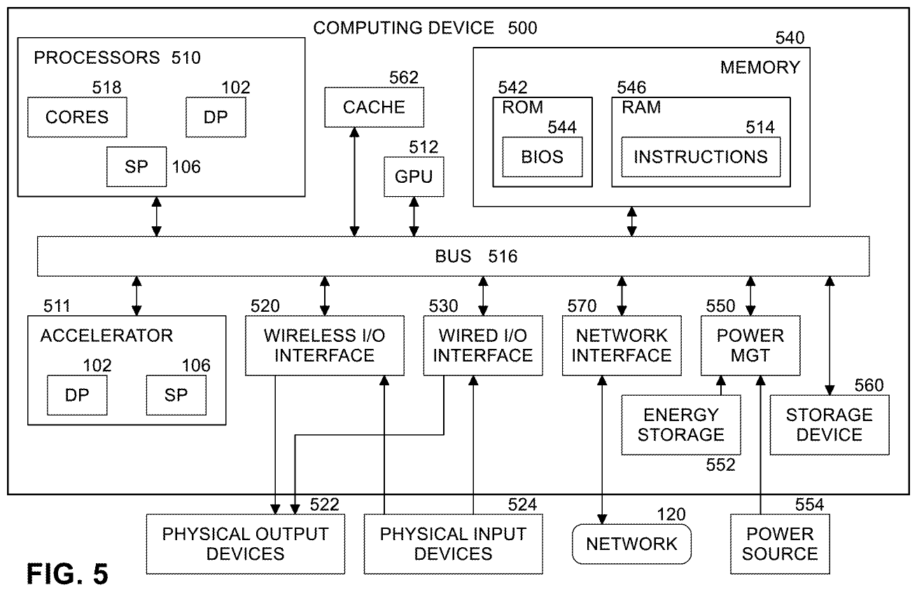

FIG. 5 is a schematic diagram of an illustrative electronic computing device to perform security processing 400 according to some embodiments. Electronic computing device 500 is representative of computing system 100. In some embodiments, computing device 500 includes one or more processors 510 including one or more processors cores 518 and including data processor (DP) 102 and security processor (SP) 106. In some embodiments, the computing device 500 includes accelerator 511, which includes DP 102 and SP 106. In some embodiments, the computing device performs security processing as described above in FIGS. 1-4.

Computing device 500 may additionally include one or more of the following processing resources: cache 562, a graphical processing unit (GPU) 512 (which may be accelerator 511 in some implementations), a wireless input/output (I/O) interface 520, a wired I/O interface 530, system memory circuitry 540, power management circuitry 550, non-transitory storage device 560, and a network interface 570 for connection to a network 120. The following discussion provides a brief, general description of the components forming the illustrative computing device 500. Example, non-limiting computing devices 500 may include a desktop computing device, blade server device, workstation, laptop computer, mobile phone, tablet computer, personal digital assistant, or similar device or system.

In embodiments, the processor cores 518 are capable of executing machine-readable instruction sets 514, reading data and/or instruction sets 514 from one or more storage devices 560 and writing data to the one or more storage devices 560. Those skilled in the relevant art will appreciate that the illustrated embodiments as well as other embodiments may be practiced with other processor-based device configurations, including portable electronic or handheld electronic devices, for instance smartphones, portable computers, wearable computers, consumer electronics, personal computers (“PCs”), network PCs, minicomputers, server blades, mainframe computers, FPGAs, Internet of Things (IOT) devices, and the like. For example, machine-readable instruction sets 514 may include instructions to implement security processing, as provided above in FIGS. 1-4.

The processor cores 518 may include any number of hardwired or configurable circuits, some or all of which may include programmable and/or configurable combinations of electronic components, semiconductor devices, and/or logic elements that are disposed partially or wholly in a PC, server, mobile phone, tablet computer, or other computing system capable of executing processor-readable instructions.

The computing device 500 includes a bus 516 or similar communications link that communicably couples and facilitates the exchange of information and/or data between various system components including the processor cores 518, the cache 562, the graphics processor circuitry 512, one or more wireless I/O interfaces 520, one or more wired I/O interfaces 530, one or more storage devices 560, one or more network interfaces 570, and/or accelerator 511. The computing device 500 may be referred to in the singular herein, but this is not intended to limit the embodiments to a single computing device 500, since in certain embodiments, there may be more than one computing device 500 that incorporates, includes, or contains any number of communicably coupled, collocated, or remote networked circuits or devices.

The processor cores 518 may include any number, type, or combination of currently available or future developed devices capable of executing machine-readable instruction sets.

The processor cores 518 may include (or be coupled to) but are not limited to any current or future developed single-core or multi-core processor or microprocessor, such as: on or more systems on a chip (SOCs); central processing units (CPUs); digital signal processors (DSPs); graphics processing units (GPUs); application-specific integrated circuits (ASICs), programmable logic units, field programmable gate arrays (FPGAs), and the like. Unless described otherwise, the construction and operation of the various blocks shown in FIG. 5 are of conventional design. Consequently, such blocks need not be described in further detail herein, as they will be understood by those skilled in the relevant art. The bus 516 that interconnects at least some of the components of the computing device 500 may employ any currently available or future developed serial or parallel bus structures or architectures.

The system memory 540 may include read-only memory (“ROM”) 542 and random-access memory (“RAM”) 546. A portion of the ROM 542 may be used to store or otherwise retain a basic input/output system (“BIOS”) 544. The BIOS 544 provides basic functionality to the computing device 500, for example by causing the processor cores 518 to load and/or execute one or more machine-readable instruction sets 514. In embodiments, at least some of the one or more machine-readable instruction sets 514 causes at least a portion of the processor cores 518 to provide, create, produce, transition, and/or function as a dedicated, specific, and particular machine, for example a word processing machine, a digital image acquisition machine, a media playing machine, a gaming system, a communications device, a smartphone, a neural network, a machine learning model, or similar devices.

The computing device 500 may include at least one wireless input/output (I/O) interface 520. The at least one wireless I/O interface 520 may be communicably coupled to one or more physical output devices 522 (tactile devices, video displays, audio output devices, hardcopy output devices, etc.). The at least one wireless I/O interface 520 may communicably couple to one or more physical input devices 524 (pointing devices, touchscreens, keyboards, tactile devices, etc.). The at least one wireless I/O interface 520 may include any currently available or future developed wireless I/O interface. Example wireless I/O interfaces include, but are not limited to: BLUETOOTH®, near field communication (NFC), and similar.

The computing device 500 may include one or more wired input/output (I/O) interfaces 530. The at least one wired I/O interface 530 may be communicably coupled to one or more physical output devices 522 (tactile devices, video displays, audio output devices, hardcopy output devices, etc.). The at least one wired I/O interface 530 may be communicably coupled to one or more physical input devices 524 (pointing devices, touchscreens, keyboards, tactile devices, etc.). The wired I/O interface 530 may include any currently available or future developed I/O interface. Example wired I/O interfaces include but are not limited to universal serial bus (USB), IEEE 1394 (“FireWire”), and similar.

The computing device 500 may include one or more communicably coupled, non-transitory, data storage devices 560. The data storage devices 560 may include one or more hard disk drives (HDDs) and/or one or more solid-state storage devices (SSDs). The one or more data storage devices 560 may include any current or future developed storage appliances, network storage devices, and/or systems. Non-limiting examples of such data storage devices 560 may include, but are not limited to, any current or future developed non-transitory machine-readable storage mediums, storage appliances or devices, such as one or more magnetic storage devices, one or more optical storage devices, one or more electro-resistive storage devices, one or more molecular storage devices, one or more quantum storage devices, or various combinations thereof. In some implementations, the one or more data storage devices 560 may include one or more removable storage devices, such as one or more flash drives, flash memories, flash storage units, or similar appliances or devices capable of communicable coupling to and decoupling from the computing device 500.

The one or more data storage devices 560 may include interfaces or controllers (not shown) communicatively coupling the respective storage device or system to the bus 516. The one or more data storage devices 560 may store, retain, or otherwise contain machine-readable instruction sets, data structures, program modules, data stores, databases, logical structures, and/or other data useful to the processor cores 518 and/or graphics processor circuitry 512 and/or one or more applications executed on or by the processor cores 518 and/or graphics processor circuitry 512. In some instances, one or more data storage devices 560 may be communicably coupled to the processor cores 518, for example via the bus 516 or via one or more wired communications interfaces 530 (e.g., Universal Serial Bus or USB); one or more wireless communications interfaces 520 (e.g., Bluetooth®, Near Field Communication or NFC); and/or one or more network interfaces 570 (IEEE 802.3 or Ethernet, IEEE 802.11, or Wi-Fi®, etc.).

Processor-readable instruction sets 514 and other programs to implement, for example, DP 102 and SP 106, logic sets, and/or modules may be stored in whole or in part in the system memory 540. Such instruction sets 514 may be transferred, in whole or in part, from the one or more data storage devices 560. The instruction sets 514 may be loaded, stored, or otherwise retained in system memory 540, in whole or in part, during execution by the processor cores 518 and/or graphics processor circuitry 512.

The computing device 500 may include power management circuitry 550 that controls one or more operational aspects of the energy storage device 552. In embodiments, the energy storage device 552 may include one or more primary (i.e., non-rechargeable) or secondary (i.e., rechargeable) batteries or similar energy storage devices. In embodiments, the energy storage device 552 may include one or more supercapacitors or ultracapacitors. In embodiments, the power management circuitry 550 may alter, adjust, or control the flow of energy from an external power source 554 to the energy storage device 552 and/or to the computing device 500. The power source 554 may include, but is not limited to, a solar power system, a commercial electric grid, a portable generator, an external energy storage device, or any combination thereof.

For convenience, the processor cores 518, the graphics processor circuitry 512, the wireless I/O interface 520, the wired I/O interface 530, the storage device 560, accelerator 511 and the network interface 570 are illustrated as communicatively coupled to each other via the bus 516, thereby providing connectivity between the above-described components. In alternative embodiments, the above-described components may be communicatively coupled in a different manner than illustrated in FIG. 5. For example, one or more of the above-described components may be directly coupled to other components, or may be coupled to each other, via one or more intermediary components (not shown). In another example, one or more of the above-described components may be integrated into the processor cores 518 and/or the graphics processor circuitry 512. In some embodiments, all or a portion of the bus 516 may be omitted and the components are coupled directly to each other using suitable wired or wireless connections.

A flowchart representative of example hardware logic, non-tangible machine-readable instructions, hardware implemented state machines, and/or any combination thereof for implementing computing device 500 (including accelerator 511), for example, are shown in FIG. 4. The machine-readable instructions may be one or more executable programs or portion(s) of an executable program for execution by a computer processor such as the processor 510 shown in the example computing device 500 discussed. The program may be embodied in software stored on a non-transitory machine-readable medium such as a CD-ROM, a floppy disk, a hard drive, a DVD, a Blu-ray disk, or a memory associated with the processor 510, but the entire program and/or parts thereof could alternatively be executed by a device other than the processor 510 and/or embodied in firmware or dedicated hardware. Further, although the example program is described with reference to the flowchart illustrated in FIG. 4, many other methods of implementing the example computing devices 500 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine-readable instructions described herein may be stored in one or more of a compressed format, an encrypted format, a fragmented format, a compiled format, an executable format, a packaged format, etc. Machine readable instructions as described herein may be stored as data (e.g., portions of instructions, code, representations of code, etc.) that may be utilized to create, manufacture, and/or produce machine executable instructions. For example, the machine-readable instructions may be fragmented and stored on one or more storage devices and/or computing devices (e.g., servers). The machine-readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine-readable instructions may be stored in multiple parts, which are individually compressed, encrypted, and stored on separate computing devices, wherein the parts when decrypted, decompressed, and combined form a set of executable instructions that implement a program such as that described herein.

In another example, the machine-readable instructions may be stored in a state in which they may be read by a computer system, but require addition of a library (e.g., a dynamic link library (DLL)), a software development kit (SDK), an application programming interface (API), etc., in order to execute the instructions on a particular computing device or other device. In another example, the machine-readable instructions may be configured (e.g., settings stored, data input, network addresses recorded, etc.) before the machine-readable instructions and/or the corresponding program(s) can be executed in whole or in part. Thus, the disclosed machine-readable instructions and/or corresponding program(s) are intended to encompass such machine-readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example process of FIG. 4 may be implemented using executable instructions (e.g., computer and/or machine-readable instructions) stored on a non-transitory computer and/or machine-readable medium such as a hard disk drive, an SSD, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended.

The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

The following examples pertain to further embodiments. Example 1 is a method including reading input data blocks from an input buffer, sending the input data blocks to one or more cryptographic circuits in a first random order; and sending data blocks having random values in a second random order to one or more of the cryptographic circuits that did not receive the input data blocks.

In Example 2, the subject matter of Example 1 can optionally include processing the input data blocks and the data blocks having random values by the cryptographic circuits to produce output data blocks; and storing one or more of the output data blocks in an output buffer.

In Example 3, the subject matter of Example 2 can optionally include wherein storing the one or more output data blocks comprises omitting storing the output data blocks produced by the cryptographic circuits that received the data blocks having random values.

In Example 4, the subject matter of Example 1 can optionally include randomly clocking one or more cryptographic circuits on a positive clock edge and randomly clocking one or more cryptographic circuits on a negative clock edge.

In Example 5, the subject matter of Example 1 can optionally include inserting random delays between sending the input data blocks to the one or more cryptographic circuits.

In Example 6, the subject matter of Example 1 can optionally include inserting random delays between sending the data blocks having random values to the one or more cryptographic circuits.

In Example 7, the subject matter of Example 1 can optionally include wherein the cryptographic circuits comprise a plurality of unrolled and pipelined cryptographic circuits operating in parallel.

In Example 8, the subject matter of Example 3 can optionally include wherein the input data blocks comprise plaintext data, the output data blocks comprise ciphertext data, and the cryptographic circuits perform encryption processing.

In Example 9, the subject matter of Example 3 can optionally include wherein the input data blocks comprise ciphertext data, the output data blocks comprise plaintext data, and the cryptographic circuits perform decryption processing.

In Example 10, the subject matter of Example 1 can optionally include a first technique of randomly clocking one or more of the cryptographic circuits on a positive clock edge and randomly clocking one or more of the cryptographic circuits on a negative clock edge, a second technique of inserting random delays between sending the input data blocks to the one or more cryptographic circuits and between sending the data blocks having random values to the one or more cryptographic circuits, a third technique of the sending the input data blocks to one or more of the cryptographic circuits in the first random order, and a fourth technique of the sending data blocks having values in the second random order to one or more cryptographic circuits that did not receive the input data blocks, the techniques performed according to settings of independently configurable parameters for the techniques in any combination.

Example 11 is an apparatus comprising a plurality of cryptographic circuits; and a scheduler to read input data blocks from an input buffer, send the input data blocks to one or more of the plurality of cryptographic circuits in a first random order; and send data blocks having random values in a second random order to one or more of the plurality of cryptographic circuits that did not receive the input data blocks.

In Example 12, the subject matter of Example 11 can optionally include the plurality of cryptographic circuits to process the input data blocks and the data blocks having random values to produce output data blocks, and the scheduler to store one or more of the output data blocks in an output buffer.

In Example 13, the subject matter of Example 12 can optionally include wherein the scheduler to store the one or more output data blocks comprises the scheduler to omit storing the output data blocks produced by the plurality of cryptographic circuits that received the data blocks having random values.

In Example 14, the subject matter of Example 11 can optionally include the scheduler to randomly clock one or more of the plurality of cryptographic circuits on a positive clock edge and randomly clock one or more of the plurality of cryptographic circuits on a negative clock edge.

In Example 15, the subject matter of Example 11 can optionally include the scheduler to insert random delays between sending the input data blocks to the one or more of the plurality of cryptographic circuits.

In Example 16, the subject matter of Example 11 can optionally include the scheduler to insert random delays between sending the data blocks having random values to the one or more cryptographic circuits.

Example 17 is a non-transitory machine-readable medium storing instructions executable by a processing resource, the instructions comprising instructions to read input data blocks from an input buffer, instructions to send the input data blocks to one or more cryptographic circuits in a first random order; and instructions to send data blocks having random values in a second random order to one or more of the cryptographic circuits that did not receive the input data blocks.

In Example 18, the subject matter of Example 17 can optionally include instructions to direct processing of the input data blocks and the data blocks having random values by the cryptographic circuits to produce output data blocks; and store one or more of the output data blocks in an output buffer.

In Example 19, the subject matter of Example 18 can optionally include instructions to store the one or more output data blocks comprises instructions to omit storing the output data blocks produced by the cryptographic circuits that received the data blocks having random values.

In Example 20, the subject matter of Example 17 can optionally include instructions to randomly clock one or more cryptographic circuits on a positive clock edge and randomly clock one or more cryptographic circuits on a negative clock edge.

In Example 21, the subject matter of Example 17 can optionally include instructions to insert random delays between sending the input data blocks to the one or more cryptographic circuits.

In Example 22, the subject matter of Example 17 can optionally include instructions to insert random delays between sending the data blocks having random values to the one or more cryptographic circuits.

Example 23 is an apparatus including a plurality of cryptographic circuits and means for reading input data blocks from an input buffer, sending the input data blocks to one or more of the plurality of cryptographic circuits in a first random order; and sending data blocks having random values in a second random order to one or more of the plurality of cryptographic circuits that did not receive the input data blocks.

What is claimed is:

1. A method comprising:
reading input data blocks from an input buffer,
sending the input data blocks to one or more cryptographic circuits in a first random order; and
sending data blocks having random values in a second random order to one or more of the cryptographic circuits that did not receive the input data blocks.

2. The method of claim 1, comprising:
processing the input data blocks and the data blocks having random values by the cryptographic circuits to produce output data blocks; and
storing one or more of the output data blocks in an output buffer.

3. The method of claim 2, wherein storing the one or more output data blocks comprises omitting storing the output data blocks produced by the cryptographic circuits that received the data blocks having random values.

4. The method of claim 1, comprising randomly clocking one or more cryptographic circuits on a positive clock edge and randomly clocking one or more cryptographic circuits on a negative clock edge.

5. The method of claim 1, comprising inserting random delays between sending the input data blocks to the one or more cryptographic circuits.

6. The method of claim 1, comprising inserting random delays between sending the data blocks having random values to the one or more cryptographic circuits.

7. The method of claim 1, wherein the cryptographic circuits comprise a plurality of unrolled and pipelined cryptographic circuits operating in parallel.

8. The method of claim 3, wherein the input data blocks comprise plaintext data, the output data blocks comprise ciphertext data, and the cryptographic circuits perform encryption processing.

9. The method of claim 3, wherein the input data blocks comprise ciphertext data, the output data blocks comprise plaintext data, and the cryptographic circuits perform decryption processing.

10. The method of claim 1, comprising a first technique of randomly clocking one or more of the cryptographic circuits on a positive clock edge and randomly clocking one or more of the cryptographic circuits on a negative clock edge, a second technique of inserting random delays between sending the input data blocks to the one or more cryptographic circuits and between sending the data blocks having random values to the one or more cryptographic circuits, a third technique of the sending the input data blocks to one or more of the cryptographic circuits in the first random order, and a fourth technique of the sending data blocks having values in the second random order to one or more cryptographic circuits that did not receive the input data blocks, the techniques performed according to settings of independently configurable parameters for the techniques in any combination.

11. An apparatus comprising:
a plurality of cryptographic circuits; and
scheduler circuitry to read input data blocks from an input buffer, send the input data blocks to one or more of the plurality of cryptographic circuits in a first random order; and send data blocks having random values in a second random order to one or more of the plurality of cryptographic circuits that did not receive the input data blocks.

12. The apparatus of claim 11, comprising the plurality of cryptographic circuits to process the input data blocks and the data blocks having random values to produce output data blocks, and the scheduler circuitry to store one or more of the output data blocks in an output buffer.

13. The apparatus of claim 12, wherein the scheduler circuitry to store the one or more output data blocks comprises the scheduler to omit storing the output data blocks produced by the plurality of cryptographic circuits that received the data blocks having random values.

14. The apparatus of claim 11, comprising the scheduler circuitry to randomly clock one or more of the plurality of cryptographic circuits on a positive clock edge and randomly clock one or more of the plurality of cryptographic circuits on a negative clock edge.

15. The apparatus of claim 11, comprising the scheduler circuitry to insert random delays between sending the input data blocks to the one or more of the plurality of cryptographic circuits.

16. The apparatus of claim 11, comprising the scheduler circuitry to insert random delays between sending the data blocks having random values to the one or more cryptographic circuits.

17. A non-transitory machine-readable medium storing instructions executable by a processing resource, the instructions comprising:
instructions to read input data blocks from an input buffer,
instructions to send the input data blocks to one or more cryptographic circuits in a first random order; and
instructions to send data blocks having random values in a second random order to one or more of the cryptographic circuits that did not receive the input data blocks.

18. The non-transitory machine-readable medium of claim 17, comprising instructions to:
direct processing of the input data blocks and the data blocks having random values by the cryptographic circuits to produce output data blocks; and
store one or more of the output data blocks in an output buffer.

19. The non-transitory machine-readable medium of claim 18, wherein instructions to store the one or more output data blocks comprises instructions to omit storing the output data blocks produced by the cryptographic circuits that received the data blocks having random values.

20. The non-transitory machine-readable medium of claim 17, comprising instructions to randomly clock one or more cryptographic circuits on a positive clock edge and randomly clock one or more cryptographic circuits on a negative clock edge.

21. The non-transitory machine-readable medium of claim 17, comprising instructions to insert random delays between sending the input data blocks to the one or more cryptographic circuits.

22. The non-transitory machine-readable medium of claim 17, comprising instructions to insert random delays between sending the data blocks having random values to the one or more cryptographic circuits.
